(19) United States
(12) Patent Application Publication
(10) Pub. No.: US 2026/0253391 A1
(43) Pub. Date: Aug. 27, 2026

(54) METHOD AND APPARATUS FOR BUILDING ADAPTIVE SCALE AWARENESS-BASED POWER TRANSMISSION DETECTION MODEL

(71) Applicants: State Grid Taizhou Power Supply Company Of State Grid Jiangsu Electric Power Co., Ltd., Jiangsu (CN); State Grid Jiangsu Electric Power Co., Ltd., Jiangsu (CN)

(72) Inventors: Xiao LU, Jiangsu (CN); Chunlei XU, Jiangsu (CN); Chengling JIANG, Jiangsu (CN); Zhoujun MA, Jiangsu (CN); Weiwei JING, Jiangsu (CN); Maofei WANG, Jiangsu (CN); Chao GAO, Jiangsu (CN); Qiwei WU, Jiangsu (CN); Yongdong DAI, Jiangsu (CN); Feng MAO, Jiangsu (CN); Shenyu WANG, Jiangsu (CN); Ling JU, Jiangsu (CN); Yanquan ZHU, Jiangsu (CN)

(73) Assignees: State Grid Taizhou Power Supply Company Of State Grid Jiangsu Electric Power Co., Ltd., Jiangsu (CN); State Grid Jiangsu Electric Power Co., Ltd., Jiangsu (CN)

(21) Appl. No.: 18/860,003

(22) PCT Filed: May 16, 2024
(86) PCT No.: PCT/CN2024/093586

§ 371 Date: Oct. 25, 2024

(30) Foreign Application Priority Data
May 26, 2023 (CN) 202310604120.1

(51) Int. Cl. G06V 10/774; G06V 10/72; G06V 10/764; G06V 10/77; G06V 10/82; G06V 20/52; G06V 20/70

(52) U.S. Cl. CPC G06V 10/774; G06V 10/72; G06V 10/764; G06V 10/7715; G06V 10/82; G06V 20/52; G06V 20/70

(57) ABSTRACT

A method and an apparatus for building an adaptive scale awareness-based power transmission detection model. The method includes the following steps: acquiring a training image data set for power transmission detection, and performing analysis processing on the training image data set; building an initial power transmission detection model that integrates awareness scale information and spatial information by using a YOLOv5 algorithm framework as a baseline; iterating parameters of the awareness scale information and the spatial information combined with the training image data set; and building an adaptive scale awareness-based power transmission detection model based on an iteration result.

### TECHNICAL FIELD

The present invention belongs to the technical field of power transmission detection, and particularly relates to a method and an apparatus for building an adaptive scale awareness-based power transmission detection model.

### BACKGROUND

Power transmission lines are composed of various components such as insulators, power towers, conductors, connectors, etc. These components play interrelated roles, and the failure or damage of one component may lead to or directly cause a super-regional power outage or even a catastrophic accident, such as a forest fire. To date, a large amount of work has been devoted to automatically identifying power transmission hazards to reduce the likelihood of power transmission failures. The use of drone inspections on power transmission lines has changed the traditional manual power inspection method, alleviating problems such as long inspection time, low labor efficiency, untimely emergency fault handling, and incomplete screening of safety hazards.

The above work has evolved from using traditional image processing technology to using deep learning methods to conduct extensive research on power line components and their defects in order to achieve the purpose of distinguishing them from manual methods. However, on the one hand, most of them are based on classification tasks of specific categories, i.e., usually focusing on a specific hazardous component and its defects. Models trained based on specific categories cannot utilize domain-specific information contained in classification tasks of related categories, resulting in low generalization performance of an intelligent detection model for power transmission hazards and their defects in actual application scenarios. On the other hand, natural images include objects of different scales. The FPN (Feature Pyramid Network)-based method combines features of adjacent two levels sequentially through a top-down path and a horizontal connection, which enhances the feature expression and allows the rich semantics of low-resolution feature maps from deep layers can be shared across all levels. Facing the tasks of detection of power transmission hazards and their defects and identification of small targets, the YOLO algorithm family based on FPN and PANet leads to its fixed network structure, which can only solve some tasks simply and effectively. The simple YOLO algorithm family cannot meet all practical needs.

For example, patent CN114821278A is a method for identifying components of a power transmission line based on improved YOLOv5, which includes: collecting an aerial image of the power transmission line, and expanding the aerial image through a data enhancement method; performing improvement based on a YOLOv5 network to increase a smaller-scale detection layer, and adding a jump connection to a PAN layer to integrate multi-path features and improve small-target detection performance; proposing a PCSA attention mechanism to integrate the feature relationships from spatial dimensions and channel dimensions and improve the saliency of targets in the image; proposing LSCIoU as a loss function of bounding box to automatically adjust the position loss size of targets of different sizes to increase the loss of small targets and targets difficult to be identified and improve the identification capacity of difficult samples; and training the improved YOLOv5 network using training set images, and testing the improved YOLOv5 network using test set images.

However, the above-mentioned prior art is still insufficient in solving actual needs. For example, (1) the solution for multi-scale objects is not efficient enough. Although FPN is a feature pyramid that shares rich semantics at all levels, features from different levels have obvious semantic gaps. PANet is a redesign following the level structure of FPN, in which the semantic gaps are only subtly avoided but do not disappear. (2) The detection performance of small instances in images is poor. For example, the distribution of insulator flashover defects and damage defects on images is characterized by large number, small size and dense distribution.

The massive amount of visible light image data taken by drones urgently needs to be analyzed and processed intelligently, and a set of reliable, efficient, low-cost and sustainable solutions are needed to address the safety hazards in power transmission.

### SUMMARY

In view of the defects existing in the above-mentioned prior art, the present invention is made from three aspects: first, breaking through the bottleneck of specific tasks and improving the generalization of the model; second, providing an optimized solution of YOLOv5 for multi-scale objects; and third, improving the performance of small instances.

In a first aspect, the present invention provides a method for building an adaptive scale awareness-based power transmission detection model, which comprises the following steps:
acquiring a training image data set for power transmission detection, and performing analysis processing on the training image data set;
building an initial power transmission detection model that integrates awareness scale information and spatial information by using a YOLOv5 algorithm framework as a baseline;
iterating parameters of the awareness scale information and the spatial information combined with the training image data set; and
building an adaptive scale awareness-based power transmission detection model based on an iteration result.

Further, the acquiring a training image data set for power transmission detection, and performing analysis processing on the training image data set specifically comprises the following steps:
performing labeling processing on training image data to acquire the training image data set comprising multiple categories of power transmission equipment and defect types; and
performing classification processing on the training image data set;
wherein the classification processing comprises performing extended enhancement on training images with fewer defect types, and performing unified merging on images with consistent label semantics.

Further, the building an initial power transmission detection model that integrates awareness scale information and spatial information by using a YOLOv5 algorithm framework as a baseline specifically comprises the following steps:
adding a small-target prediction layer to a FPN structure of neck by using the YOLOv5 algorithm framework as the baseline;

connecting an adaptive scale-aware module to an output end of the FPN structure, connecting a spatial-aware module to an input end of a PANet structure, and connecting the adaptive scale-aware module to the spatial-aware module; and
building an initial power transmission detection model that integrates awareness scale information and spatial information.

Further, the iterating parameters of the awareness scale information and the spatial information combined with the training image data set specifically comprises the following steps:

collecting training images by the initial power transmission detection model, and obtaining a multi-level feature map with a predetermined step size in a backbone structure, the multi-level feature map C={C₁, C₂, . . . , Cₙ}, wherein C₁ is a first-level feature map, C₂ is a second-level feature map, Cₙ is an n(th)-level feature map, and n corresponds to the number of levels of the feature pyramid map;
sorting the multi-level feature map by level, and performing horizontal and top-down connections from a lower level to form a feature pyramid, the feature pyramid S={S₁, S₂, . . . , Sₙ}, wherein S₁ is a first-level feature pyramid map, S₂ is a second-level feature pyramid map, and Sₙ is an n(th)-level feature pyramid map;
performing dimension and spatial weight processing on the feature pyramid map at each level of the feature pyramid in the adaptive scale-aware module to obtain a feature map of the awareness scale information;
performing offset and attention processing on the feature map of the awareness scale information in the spatial-aware module to obtain a feature map of the awareness scale information and the spatial information;
giving an identified image result combined with the PANet structure; and
based on the image result, iterating dimension and spatial weight parameters in the adaptive scale-aware module and offset and attention parameters in the spatial-aware module.

Further, the performing dimension weight processing on the feature pyramid map at each level of the feature pyramid in the adaptive scale-aware module specifically comprises the following step:
determining a lowest-level feature pyramid map of the feature pyramid, and expanding the feature pyramid maps at the remaining levels of the feature pyramid by a predetermined fold, which is specifically expressed as:

$${X}^{k} , k ∈ [ 2 , n ] ⊆ S [ 1 , n ]$$

$$\{ \begin{matrix}\frac{{T}_{x}}{{O}_{x}} = \frac{{T}_{w}}{{O}_{w}} \\ \frac{{T}_{y}}{{O}_{y}} = \frac{{T}_{H}}{{O}_{H}}\end{matrix}$$

wherein, X^{k} is an expanded feature pyramid map, T_{w} and T_{H} are the width and height of the expanded feature pyramid map, Tₓ and T_{y} are the horizontal and vertical coordinates of the expanded feature pyramid map, O_{w} and O_{H} are the width and height of the feature pyramid map, and Oₓ and O_{y} are the horizontal and vertical coordinates of the feature pyramid map.

Further, the performing spatial weight processing on the feature pyramid map at each level of the feature pyramid in the adaptive scale-aware module specifically comprises the following steps:
obtaining pixel coordinates of the expanded feature pyramid map, and determining different levels of control weight factors of each pixel coordinate; and
based on the different levels of control weight factors, completing the spatial weight processing for the expanded feature pyramid map.

Further, the spatial weight processing for the expanded feature pyramid map is specifically expressed as follows:

$${x}_{ij}^{′} = {α}_{ij}^{1} \cdot {x}_{i j}^{1} + {α}_{ij}^{2} \cdot {x}_{ij}^{2} + … + {α}_{ij}^{n} \cdot {x}_{ij}^{n}$$

$${α}_{ij}^{1} + {α}_{ij}^{2} + … + {α}_{ij}^{n} = 1$$

$${α}_{ij}^{1} , {α}_{ij}^{2} , … , {α}_{ij}^{n} ∈ [ 0 , 1 ]$$

wherein, xᵢⱼ′ is a pixel of the feature map of the awareness scale information obtained by the adaptive scale-aware module,

$${x}_{ij}^{1} , {x}_{ij}^{2} and {x}_{ij}^{n}$$

are respectively pixels on the first-level, second-level and n(th)-level feature pyramid maps expanded,

$${α}_{ij}^{1} , {α}_{ij}^{2} and {α}_{ij}^{n}$$

are first, second and n(th)-level control weight factors corresponding to the pixels, and ij is a pixel coordinate on the expanded feature pyramid map.

Further, the performing offset and attention processing on the feature map of the awareness scale information in the spatial-aware module to obtain a feature map of the awareness scale information and the spatial information specifically comprises the following steps:
obtaining an offset mask and an attention mask of the feature map of the awareness scale information through convolution and group normalization, wherein the attention mask is obtained based on an activation function;
performing analysis processing on the offset mask, and processing the feature map of the awareness scale information combined with a numerical value of the attention mask, wherein the attention mask is a logistic regression function of 0 or a positive number; and
obtaining the feature map of the awareness scale information and the spatial information.

Further, the performing analysis processing on the offset mask specifically comprises the following step:
rounding offset coordinates in the offset mask using a max pooling method to obtain corrected coordinates, and determining an offset pixel;
the attention mask being obtained based on an activation function is specifically expressed as follows:

$$∅ ( x ) = max ( 0 , \frac{tanh ( x - φ ) + tanh ( φ )}{1 + tanh ( φ )} ) ∈ [ 0 , 1 ]$$

wherein Ø(x) is the attention mask for obtaining the feature map x of the awareness scale information, x is the feature map of the awareness scale information, φ is a preset hyperparameter, and tanh is a hyperbolic tangent function; and
the obtaining the feature map of the awareness scale information and the spatial information is specifically expressed as follows:

$$y = {\sum }_{k = 1}^{K} {∅}_{k} \cdot {w}_{0} x ( {p}_{0} + Δ {p}_{k} )$$

wherein y is the feature map of the awareness scale information and the spatial information, k is a serial number of a sampling point at a pixel point p₀, K is the total number of sampling points at the pixel point p₀, Øₖ is an attention mask of a k(th) sampling point, w₀ is a weight of the pixel point p₀ in the feature map x of the awareness scale information, p₀ is a pixel point on the feature map x of the awareness scale information, and Δpₖ is an offset mask of the k(th) sampling point.

In a second aspect, the present invention further provides an apparatus for building an adaptive scale awareness-based power transmission detection model, which uses the method for building an adaptive scale awareness-based power transmission detection model described above, and comprises:
an acquisition module, configured to acquire a training data set for power transmission detection;
an analysis module, configured to perform analysis processing on the training data set, and iterates parameters of awareness scale information and spatial information combined with the training data set; and
a building module, configured to build an initial power transmission detection model that integrates the awareness scale information and the spatial information by using a YOLOv5 algorithm framework as a baseline, and to build an adaptive scale awareness-based power transmission detection model based on an iteration result.

The method and apparatus for building an adaptive scale awareness-based power transmission detection model provided in the present invention include at least the following technical effects:
(1) According to the present invention, the bottleneck of specific tasks is broken through, a more complete data set is built from hazardous components in power transmission such as insulators, power towers, and conductors, and a multi-component detection and small-target identification model for power transmission hazards and their defects are studied. The detection and identification model can identify power transmission line defect types such as insulator cap leakage and flashover, bird nests on power towers and foreign matters on power lines, and use the domain-specific information of these similar tasks to improve the generalization of the model, so that the model is more suitable for application in actual industrial scenarios.

(2) The baseline method used in the present invention is the YOLOv5 algorithm model, which uses an adaptive scale-aware method to solve semantic gaps. Adaptive scale awareness filters conflicts and retains useful information from the spatial and scale levels, as a result, more accurate semantic information and finer detail information are obtained, the performance of multi-scale target detection is improved, the model is more robust, the hardware cost and the performance are balanced, effective reasoning can be directly performed on inputs of single images and batch images, the detection speed is improved, the volume of the model is reduced, and real-time and high-precision detection requirements in industrial application scenarios can be satisfied.

(3) The model built in the present invention integrates scale information and spatial information, and uses the spatial-aware module to improve the performance of small-target instances, and uses the finer information provided by the adaptive scale-aware module as a main clue such that the spatial-aware module can be aware of the spatial position of small-target instances on the detail information-rich feature map, thereby achieving the more accurate positioning of small-instance targets.

(4) The present invention achieves the optimization in structure and computation speed of the adaptive scale-aware module and the spatial-aware module, and reduces the parameters and computation complexity of the model.

### BRIEF DESCRIPTION OF THE DRAWINGS

FIG. 1 is a schematic structural diagram of a YOLOv5 algorithm model in the prior art;

FIG. 2 is a schematic flow chart of building an adaptive scale awareness-based power transmission detection model according to the present invention;

FIG. 3 is a schematic structural diagram of an initial power transmission detection model that integrates awareness scale information and spatial information built according to the present invention;

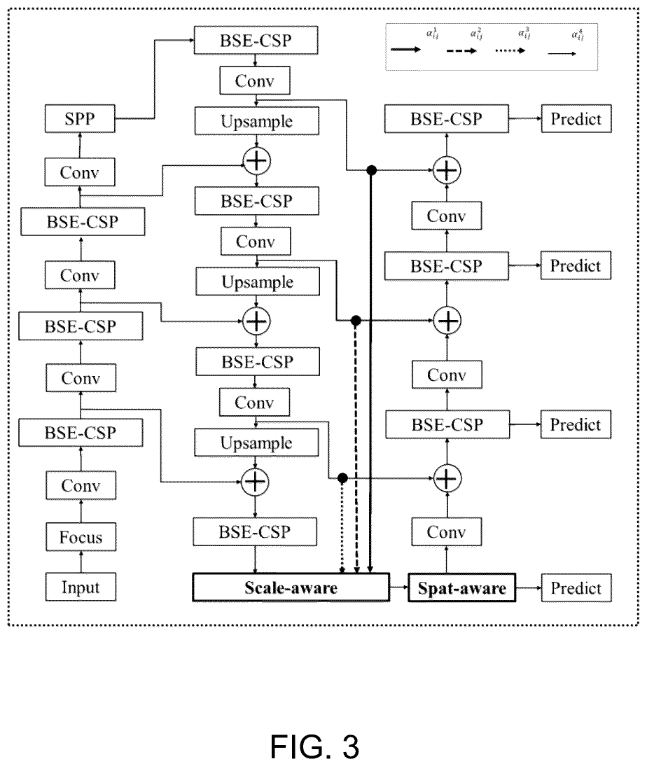

FIG. 4 is a schematic structural diagram of obtaining a feature map of the awareness scale information according to the present invention; and

FIG. 5 is a schematic structural diagram of obtaining a feature map of the awareness scale information and the spatial information according to the present invention.

### DETAILED DESCRIPTION OF THE INVENTION

In order to better understand the above technical solution, the above technical solution will be described in detail below with reference to the accompanying drawings and specific implementations. Apparently, the described embodiments are merely some rather than all of the embodiments of the present invention. On the basis of the embodiments in the present invention, all other embodiments obtained by those of ordinary skill in the art without making creative efforts all fall within the scope of protection of the present invention.

The terms used in the embodiments of the present invention are merely for the purpose of describing specific embodiments, and are not intended to limit the present invention. The singular forms “a”, “an” and “the” used in the embodiments of the present invention and the appended claims are also intended to include the plural forms, and “a plurality of” usually includes at least two, unless the context clearly indicates otherwise.

It should also be noted that the terms “comprise”, “include” or any other variants thereof are intended to cover non-exclusive inclusions, so that a product or apparatus including a series of elements not only includes those elements, but also includes other elements that are not explicitly listed, or further includes elements inherent to the product or apparatus. Without more constraints, an element defined by the phrase “comprising a . . . ” does not exclude the existence of additional identical elements in the product or apparatus comprising the element.

The technical problem to be solved by the present invention include three aspects: first, breaking through the bottleneck of specific tasks and improving the generalization of the model; second, providing an optimized solution of YOLOv5 for multi-scale objects; and third, improving the performance of small instances.

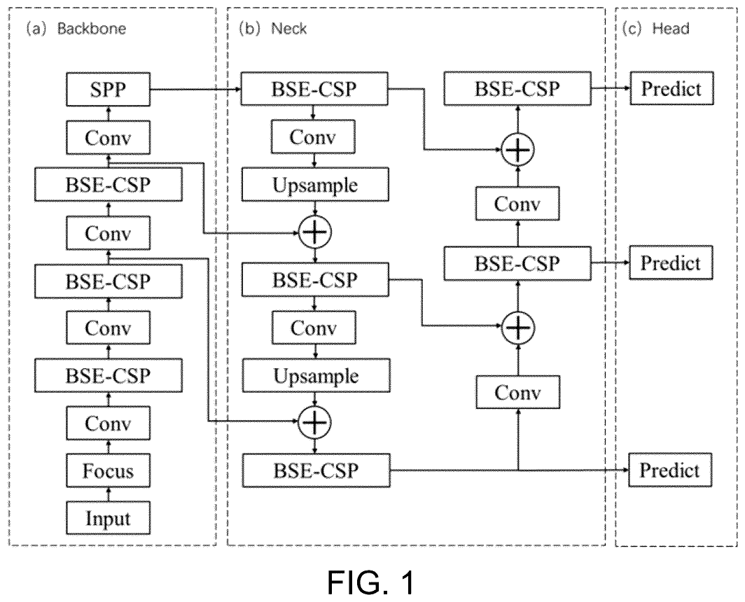

As shown in FIG. 1, the present invention provides a method for building an adaptive scale awareness-based power transmission detection model, which includes the following steps:
acquiring a training image data set for power transmission detection, and performing analysis processing on the training image data set;
building an initial power transmission detection model that integrates awareness scale information and spatial information by using a YOLOv5 algorithm framework as a baseline;
iterating parameters of the awareness scale information and the spatial information combined with the training image data set; and
building an adaptive scale awareness-based power transmission detection model based on an iteration result.

The acquiring a training image data set for power transmission detection, and performing analysis processing on the training image data set specifically includes the following steps:
performing labeling processing on training image data to acquire the training image data set comprising multiple categories of power transmission equipment and defect types; and
performing classification processing on the training image data set;
where the classification processing includes performing extended enhancement on training images with fewer defect types, and performing unified merging on images with consistent label semantics.

In a certain embodiment, a data set including insulator cap leakage, insulator flashover, bird nest invasion on power towers, foreign matters on conductors, etc. is built, which includes more than 10,000 images. Steps such as annotating images, enhancing data, merging and dividing data sets are included. The data set is divided into a training set and a test set in a ratio of 7:3. The images in the training set are fed into a neural network for model training. A total of 300 epochs are required with a batch size of 16. A Pytorch deep learning framework is used, the Python version is 3.6.0, and the GPU is Nvidia GeForce GTX 3090 (24G). When the training is finished, the best training weight will be saved and used to verify the test data set, outputting the results of each evaluation index corresponding to each category of targets, including precision, recall, F1-Score, mAP@0.5 and mAP@0.5:0.95, etc.

Compared with existing public data sets, the data set includes hazardous components in power transmission of more categories and richer defects and their defects. Then, the data distribution of the data set is analyzed, and a suitable deep learning algorithm architecture is designed to adapt to the target characteristics of multiple components at different scales and their defects, so as to achieve the detection on power transmission hazards and their defects.

Since the images collected by drones have high-definition resolution, in order to reduce the computational cost, each image in the data set needs to be fixed to a size of 640×640 as an input of YOLOv5. Therefore, it is necessary to compute a shrinkage ratio of each image in length and width directions and select the smallest shrinkage ratio. The length and width of the shrunken image are computed using the shrinkage ratio to determine the size of pixels that need to be filled.

To build the data set, the collected images should be annotated. A Label Img annotation method is used to save the coordinate position and category of a target in the image in txt format to form a label file. For a small number of defect types, the data set can be extended using eight data enhancement methods including cropping, translation, brightness change, noise addition, rotation, mirroring, Cutout and Mosic enhancement.

Before mixing data sets, for two or more datasets with repeated labels or overlapping classes, all semantically consistent labels containing such cases need to be unified. Data sets for similar tasks cannot be simply merged because there may be conflicts. The first is that there are repeated labels or overlapping classes. Therefore, label correction and unification need to be performed. The second is that there are conflicts between positive and negative samples. The data sets for similar tasks all include targets to be identified after the data sets are mixed, such as insulators and bird nests. However, before mixing, in a data set A, the insulator is in the label category and trained as a positive sample, and the bird nest is the background and is a negative sample. In a data set B, the insulator is the background and is a negative sample, and the bird nest is a positive sample. Such conflicts between positive and negative samples will interfere with model training and affect performance improvement. Therefore, it is necessary to screen the data sets and re-annotate the data for such conflicts.

Finally, a conflict-free and extended data set formed after processing is merged with a public insulator cap leakage defect data set UPID to form a more complete data set.

For designing a suitable deep learning algorithm architecture, a good baseline method should be selected and is further improved. In the present invention, a YOLOv5 algorithm which is popular in practical industrial applications is selected. The YOLOv5 algorithm includes three parts: backbone, neck (FPN and PANet), and head. In the backbone, BottleneckCSP is used as a residual structure to learn more features, which takes into account the equal effect of each channel feature.

The building an initial power transmission detection model that integrates awareness scale information and spatial information by using a YOLOv5 algorithm framework as a baseline specifically includes the following steps:
adding a small-target prediction layer to a FPN structure of neck by using the YOLOv5 algorithm framework as the baseline;
connecting an adaptive scale-aware module to an output end of the FPN structure, connecting a spatial-aware module to an input end of a PANet structure, and connecting the adaptive scale-aware module to the spatial-aware module; and
building an initial power transmission detection model that integrates awareness scale information and spatial information.

The YOLOv5 algorithm is used as a baseline algorithm model (see FIG. 1). Its backbone includes BSE-CSP, and a residual block Bottleneck in its BottleneckCSP is embedded in an existing method SENet. SENet is a plug-and-play module that mainly includes Squeeze and Excitation operations.

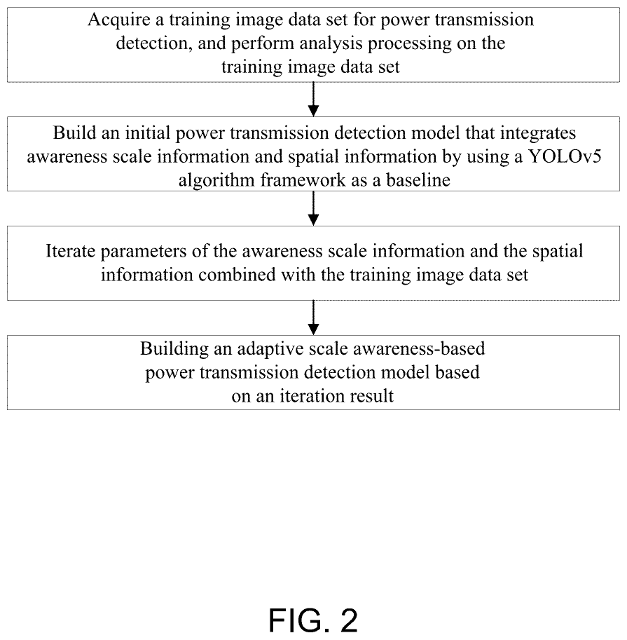

As shown in FIG. 2, the technical solution provided by the present invention is that the YOLOv5 algorithm is used as a baseline method, however, the backbone of subsampling feature extraction is reserved to extract a feature pyramid FPN that transfers more semantic features from top to bottom to low-resolution feature maps. At the same time, a small-target prediction layer is added, that is, there are four prediction layers in total. The small-target prediction layer is a pyramid feature layer for predicting small targets. The small-target prediction layer corresponds to a 4×4 receptive field on an image. An optimized solution of YOLOv5 is provided for multi-scale objects, and the adaptive scale-aware module is utilized. A FPN underlying feature map has a property similar to that of a high-resolution feature map, that is, detail information is rich. The module makes full use of the feature map to screen out more effective detail information.

The iterating parameters of the awareness scale information and the spatial information combined with the training image data set specifically includes the following steps:
collecting training images by the initial power transmission detection model, and obtaining a multi-level feature map with a predetermined step size in a backbone structure, the multi-level feature map C={C₁, C₂, . . . , Cₙ}, where C₁ is a first-level feature map, C₂ is a second-level feature map, Cₙ is an n(th)-level feature map, and n corresponds to the number of levels of the feature pyramid map;
sorting the multi-level feature map by level, and performing horizontal and top-down connections from a lower level to form a feature pyramid, the feature pyramid S={S₁, S₂, . . . , Sₙ}, where S₁ is a first-level feature pyramid map, S₂ is a second-level feature pyramid map, and Sₙ is an n(th)-level feature pyramid map;
performing dimension and spatial weight processing on the feature pyramid map at each level of the feature pyramid in the adaptive scale-aware module to obtain a feature map of the awareness scale information;
performing offset and attention processing on the feature map of the awareness scale information in the spatial-aware module to obtain a feature map of the awareness scale information and the spatial information;
giving an identified image result combined with the PANet structure; and
based on the image result, iterating dimension and spatial weight parameters in the adaptive scale-aware module and offset and attention parameters in the spatial-aware module.

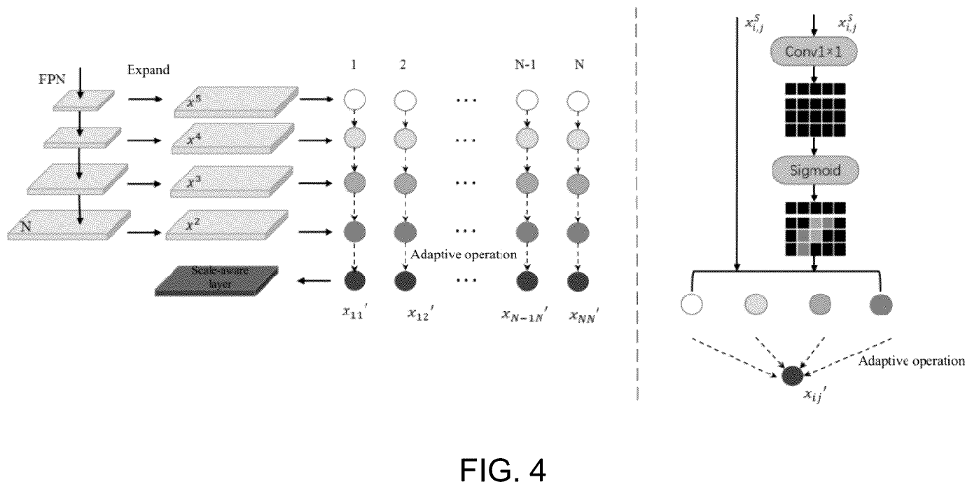

As shown in FIG. 4, for an image processed by an adaptive image scaling technology, a size of 3×640×640 is used as an input of the model of the present embodiment. A Focus module performs a slicing operation on the image so that three channels of a RGB image become 12 channels. The slicing operation refers to taking a value for every other pixel in an image. Then, the extraction of features of the neural network is performed by Conv (convolution) down-sampling and residual layer BSE-CSP for three times in sequence. It should be noted that the number of residual blocks (Bottlebeck) used by the residual layer BSE-CSP for three times is different. From shallow to deep networks, BSE-CSP uses 1 residual block, 3 residual blocks, and 3 residual blocks respectively. In the backbone, YOLOv5 performs five-fold down-sampling to obtain four levels of feature maps with a step size of 4, 8, 16 and 32, respectively, which is denoted as C={C₂, C₃, C₄, C₅}. Relatively high-level features in C are upsampled through FPN, and relatively low-level features are connected from top to bottom to form a feature pyramid, which is denoted as S={S₂, S₃, S₄, S₅}, where S₅ is the highest level, and S₂ is the lowest level. The feature pyramid corresponds to the 9th, 13th, 17th and 21st layers of the network respectively. The 21st-layer feature map S₂ of the feature pyramid is obtained by splicing its upper-level adjacent feature map with the C₂ feature map, and C₂ is a high-resolution feature map. The four-layer feature map S is used as an input of the adaptive scale-aware module. At the same time, the prediction layer is based on the four layers, and the feature map output by the adaptive scale-aware module will be input to the next module.

The performing dimension weight processing on the feature pyramid map at each level of the feature pyramid in the adaptive scale-aware module specifically includes the following step:
determining a lowest-level feature pyramid map of the feature pyramid, and expanding the feature pyramid maps at the remaining levels of the feature pyramid by a predetermined fold, which is specifically expressed as:

$${X}^{k} , k ∈ [ 2 , n ] ⊆ S [ 1 , n ]$$

$$\{ \begin{matrix}\frac{{T}_{x}}{{O}_{x}} = \frac{{T}_{w}}{{O}_{w}} \\ \frac{{T}_{y}}{{O}_{y}} = \frac{{T}_{H}}{{O}_{H}}\end{matrix}$$

wherein, X^{k} is an expanded feature pyramid map, T_{w} and T_{H} are the width and height of the expanded feature pyramid map, Tₓ and T_{y} are the horizontal and vertical coordinates of the expanded feature pyramid map, O_{w} and O_{H} are the width and height of the feature pyramid map, and Oₓ and O_{y} are the horizontal and vertical coordinates of the feature pyramid map.

To obtain a feature map with the size of S₂, the S₅, S₄ and S₃ feature maps need to be expanded by 8 times, 4 times and 2 times respectively. The expanded feature map is recorded as X^{k}, k∈[3,5]⊆S[2,5]. Since the S₂ feature map is not processed in any way, the expanded feature map corresponds to X². The expanded feature map is computed using the formula. The width and height of a target feature map are recorded as T_{w} and T_{H}, and the horizontal and vertical coordinates are recorded as (Tₓ, T_{y}). The width and height of the original feature map are recorded as O_{w} and O_{H}, and the horizontal and vertical coordinates are recorded as (Oₓ, O_{y}). Then

$$\frac{{T}_{x}}{{O}_{x}} = \frac{{T}_{w}}{{O}_{w}} , \frac{{T}_{y}}{{O}_{y}} = \frac{{T}_{H}}{{O}_{H}} .$$

The performing spatial weight processing on the feature pyramid map at each level of the feature pyramid in the adaptive scale-aware module specifically includes the following steps:
obtaining pixel coordinates of the expanded feature pyramid map, and determining different levels of control weight factors of each pixel coordinate; and
based on the different levels of control weight factors, completing the spatial weight processing for the expanded feature pyramid map.

The spatial weight processing for the expanded feature pyramid map is specifically expressed as follows:

$$\begin{matrix}{x}_{ij}^{′} = {α}_{ij}^{1} \cdot {x}_{ij}^{1} + {α}_{ij}^{2} \cdot {x}_{ij}^{2} + … + {α}_{ij}^{n} \cdot {x}_{ij}^{n} \\ {α}_{ij}^{1} + {α}_{ij}^{2} + … + {α}_{ij}^{n} = 1 \\ {α}_{ij}^{1} , {α}_{ij}^{2} , … , {α}_{ij}^{n} ∈ [ 0 , 1 ]\end{matrix}$$

wherein, xᵢⱼ′ is a pixel of the feature map of the awareness scale information obtained by the adaptive scale-aware module,

$${x}_{ij}^{1} , {x}_{ij}^{2} and {x}_{ij}^{n}$$

are respectively pixels on the first-level, second-level and n(th)-level feature pyramid maps expanded,

$${α}_{ij}^{1} , {α}_{ij}^{2} and {α}_{ij}^{n}$$

are first, second and n(th)-level control weight factors corresponding to the pixels, and ij is a pixel coordinate on the expanded feature pyramid map.

For the above feature map X^{S}, S∈[2,5], S corresponds to a certain level of FPN. Adaptive scale awareness should not only consider the scale dimension, but also combine the spatial dimension. In space, each pixel coordinate on the expanded feature map is (i, j), denoted by xᵢⱼ. Each pixel xᵢⱼ corresponds to a control weight factor

$${α}_{ij}^{1} ,$$

and the control weight factor of the expanded feature map is denoted as

$$[ {α}_{ij}^{1} , {α}_{ij}^{2} , {α}_{ij}^{3} , {α}_{ij}^{4} ] .$$

The lowest-level feature map of FPN is connected to a high-resolution feature map of a backbone network through a horizontal path, and thus has global detail information. At each spatial position, the different values of the spatial weights learned through network training are adapted, so that the network automatically trades off the filtering of conflicts and the retention of useful information. The semantic information with different richness learned at different network levels of FPN is learned, so the model can be effectively aware of scales. The feature map subjected to adaptive scale awareness has more accurate semantic information and more effective detail information, which is crucial to improving the accuracy of small instances.

The performing offset and attention processing on the feature map of the awareness scale information in the spatial-aware module to obtain a feature map of the awareness scale information and the spatial information specifically includes the following steps:
obtaining an offset mask and an attention mask of the feature map of the awareness scale information through convolution and group normalization, where the attention mask is obtained based on an activation function;
performing analysis processing on the offset mask, and processing the feature map of the awareness scale information combined with a numerical value of the attention mask, where the attention mask is a logistic regression function of 0 or a positive number; and
obtaining the feature map of the awareness scale information and the spatial information.
rounding offset coordinates in the offset mask using a max pooling method to obtain corrected coordinates, and determining an offset pixel;
the attention mask being obtained based on an activation function is specifically expressed as follows:

$$∅ ( x ) = max ( 0 , \frac{tanh ( x - φ ) + tanh ( φ )}{1 + tanh ( φ )} ) ∈ [ 0 , 1 ]$$

where Ø(x) is the attention mask for obtaining the feature map x of the awareness scale information, x is the feature map of the awareness scale information, φ is a preset hyperparameter, and tanh is a hyperbolic tangent function; and
φ is used to control a gradient at 0⁺. When φ is zero, the equation degenerates to take a larger value between the tanh( ) activation function and 0. When e is set to a positive value, the gradient at 0⁺ decreases, which alleviates discontinuous singularities at zero.

The obtaining a feature map of the awareness scale information and the spatial information is specifically expressed as follows:

$$y = {\sum }_{k = 1}^{K} {∅}_{k} \cdot {w}_{0} x ( {p}_{0} + Δ {p}_{k} )$$

where y is the feature map of the awareness scale information and the spatial information, k is a serial number of a sampling point at a pixel point p₀, K is the total number of sampling points at the pixel point p₀, Øₖ is an attention mask of a k(th) sampling point, w₀ is a weight of the pixel point p₀ in the feature map x of the awareness scale information, p₀ is a pixel point on the feature map x of the awareness scale information, and Δpₖ is an offset mask of the k(th) sampling point.

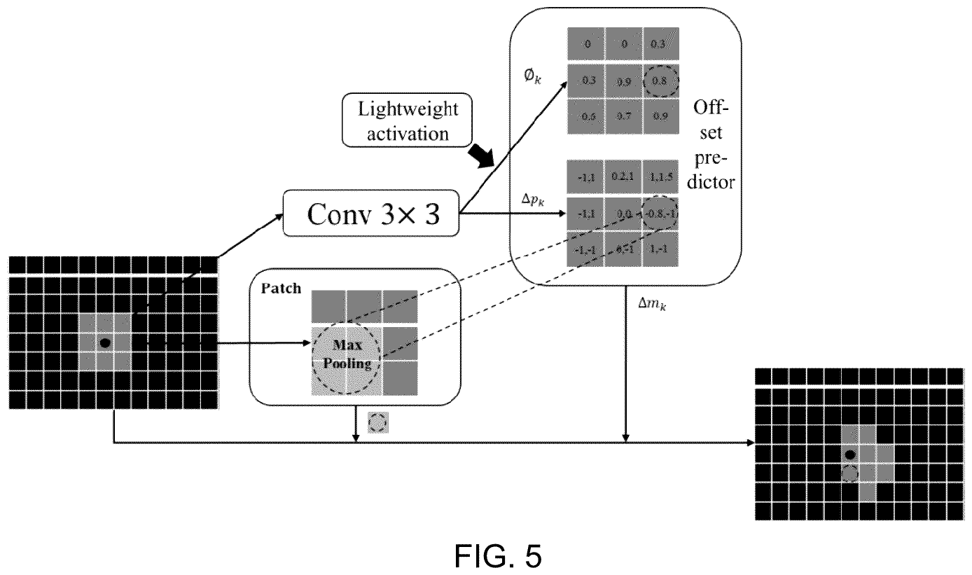

As shown in FIG. 5, an output of the adaptive scale-aware module is taken as an input of the spatial-aware module. The finer detail information provided by the adaptive scale-aware module serves as a main clue, so that the spatial-aware module can be aware of the spatial positions of small instance targets on the feature map with rich detail information.

The present invention takes into account that searching for spatial positions on the feature map has a large computational overhead. In order to reduce the computational complexity, the spatial-aware module is a lightweight method.

The spatial-aware module should include: for an input feature map for the spatial-aware module, it is denoted as x∈R^{C×H×W}. 3×3 convolution and group normalization are performed on x to obtain an offset mask of 2C and an attention mask. The offset mask represents position offset coordinates of nine sampling points obtained by sampling a certain pixel point on the input feature map, and the attention mask represents a score of an importance degree learned by the sampling point relative to the pixel point. Therefore, the obtaining the feature map of the awareness scale information and the spatial information is specifically expressed as follows:

$$y = {\sum }_{k = 1}^{K} {∅}_{k} \cdot {w}_{0} x ( {p}_{0} + Δ {p}_{k} )$$

Δpₖ described in this formula represents an offset value of a k(th) sampling point, Ok represents an attention mask of the k(th) sampling point, and w₀ represents a weight of the pixel point p₀. The sampling point K=9, and K<<H×W is set.

The spatial-aware module should further include: for the lightweight method, on the one hand, the attention mask obtained uses an activation function. The characteristic of this activation is that when the input is negative, the output of the function is always 0, which does not allow additional parameters to be generated during the inference phase, and when the input is positive, the function becomes a differentiable logistic regression function, allowing for back propagation. By activating the activation function, the speed at the time of inference is accelerated. On the other hand, in the offset mask obtained, for the offset coordinates of floating-point numbers, Patch in the figure represents that 3×3 sampling is performed on a red pixel point. For a certain sampling point (coordinates: (−0.8, −1)), it is necessary to offset 0.8 pixels to the left relative to the red pixel point and then offset 1 pixel down on the original feature map x. Upward offsetting coordinate values are positive, and rightward offsetting coordinate values are positive. Then, for such an offset with a non-integer value, the present invention selects four adjacent pixels around the offset position and performs max pooling on the four pixels to determine the offset pixel of the sampling point on the feature map. The max pooling method has lower computational complexity than the nearest neighbor interpolation method, because the nearest neighbor interpolation requires computing the distances between the offset position and the four neighboring pixels, and then sorting the distances to obtain a neighboring pixel with the nearest Euclidean distance as the offset pixel to be solved.

In this way, semantic features and detail features obtained in the adaptive scale-aware module will serve as main clues. In the space of the entire feature map, the spatial-aware module will find its more effective receptive field according to the main clues. The acquisition of this receptive field further filters out irrelevant detailed background information, and small instance targets can be accurately positioned. During prediction, the accuracy of the model in target classification and regression tasks can be improved.

The four prediction layers further complete regression and classification tasks. The training iteration with a batch size=16 and epoch=300 is set to detect power transmission line hazards and their defects in the image.

By performing max pooling on four adjacent pixel points, a final pixel point (indicated by a dashed circle) is obtained, and the pixel point is a real sampling point. The Øₖ value of the pixel is 0.8, which means that there is an 80% chance that this sampling point is a point that needs to be focused on. Finally, the figure shows the positional relationship between the black solid pixel point and a certain real sampling point output by Patch in the newly generated feature map, and the position change of the black solid pixel point in the feature map after sampling is performed for nine times. In this way, the semantic features and detail features obtained in the adaptive scale-aware module will serve as main clues. In the space of the entire feature map, the spatial-aware module will find its more effective receptive field according to the main clues. The acquisition of this receptive field further filters out irrelevant detailed background information, and small instance targets can be accurately positioned. During prediction, the accuracy of the model in target classification and regression tasks can be improved.

Although the preferred embodiments of the present invention have been described, those skilled in the art may make additional changes and modifications to these embodiments once they know the basic inventive concept. Therefore, the appended claims are intended to be interpreted as including the preferred embodiments and all changes and modifications falling within the scope of the present invention. Apparently, those skilled in the art may make various modifications and variations to the present invention without departing from the spirit and scope of the present invention. In this way, if these modifications and variations of the present invention fall within the scope of the claims of the present invention and their equivalents, the present invention is also intended to include these modifications and variations.

1. A method for building an adaptive scale awareness-based power transmission detection model, comprising the following steps:
acquiring a training image data set for a power transmission detection, and performing an analysis processing on the training image data set;
building an initial power transmission detection model that integrates an awareness scale information and a spatial information by using a YOLOv5 algorithm framework as a baseline;
iterating parameters of the awareness scale information and the spatial information combined with the training image data set; and
building the adaptive scale awareness-based power transmission detection model based on an iteration result.

2. The method for building the adaptive scale awareness-based power transmission detection model according to claim 1, wherein the acquiring a training image data set for the power transmission detection, and performing the analysis processing on the training image data set specifically comprises the following steps:
performing a labeling processing on training image data to acquire the training image data set comprising multiple categories of power transmission equipment and defect types; and
performing a classification processing on the training image data set;
wherein the classification processing comprises performing an extended enhancement on training images with fewer the defect types, and performing a unified merging on images with consistent label semantics.

3. The method for building the adaptive scale awareness-based power transmission detection model according to claim 1, wherein the building the initial power transmission detection model that integrates the awareness scale information and the spatial information by using the YOLOv5 algorithm framework as the baseline specifically comprises the following steps:
adding a small-target prediction layer to a FPN structure of neck by using the YOLOv5 algorithm framework as the baseline;
connecting an adaptive scale-aware module to an output end of the FPN structure, connecting a spatial-aware module to an input end of a PANet structure, and connecting the adaptive scale-aware module to the spatial-aware module; and
building an initial power transmission detection model that integrates the awareness scale information and the spatial information.

4. The method for building the adaptive scale awareness-based power transmission detection model according to claim 3, wherein iterating the parameters of the awareness scale information and the spatial information combined with the training image data set specifically comprises the following steps:
collecting the training images by the initial power transmission detection model, and obtaining a multi-level feature map with a predetermined step size in a backbone structure, the multi-level feature map C={C₁, C₂, . . . , Cₙ}, wherein C₁ is a first-level feature map, C₂ is a second-level feature map, Cₙ is an n-th level feature map, and n corresponds to a number of levels of a feature pyramid map;
sorting the multi-level feature map by level, and performing horizontal and top-down connections from a lower level to form a feature pyramid, the feature pyramid S={S₁, S₂, . . . , Sₙ}, wherein S₁ is a first-level feature pyramid map, S₂ is a second-level feature pyramid map, and Sₙ is an n-th level feature pyramid map;
performing dimension and spatial weight processing on the feature pyramid map at each level of the feature pyramid in the adaptive scale-aware module to obtain a feature map of the awareness scale information;
performing offset and attention processing on the feature map of the awareness scale information in the spatial-aware module to obtain a feature map of the awareness scale information and the spatial information;
giving an identified image result combined with the PANet structure; and
based on an image result, iterating dimension and spatial weight parameters in the adaptive scale-aware module and offset and attention parameters in the spatial-aware module.

5. The method for building the adaptive scale awareness-based power transmission detection model according to claim 4, wherein the performing the dimension weight processing on the feature pyramid map at each level of the feature pyramid in the adaptive scale-aware module specifically comprises the following step:
determining a lowest-level feature pyramid map of the feature pyramid, and expanding the feature pyramid map at the remaining levels of the feature pyramid by a predetermined fold, which is specifically expressed as:
$$\begin{matrix}{X}^{k} , k ∈ [ 2 , n ] ⊆ S [ 1 , n ] \\ \{ \begin{matrix}\frac{{T}_{x}}{{O}_{x}} = \frac{{T}_{w}}{{O}_{w}} \\ \frac{{T}_{y}}{{O}_{y}} = \frac{{T}_{H}}{{O}_{H}}\end{matrix}\end{matrix}$$
wherein, X^{k} is an expanded feature pyramid map, T_{w} and T_{H} are width and height of the expanded feature pyramid map, Tₓ and T_{y} are horizontal and vertical coordinates of the expanded feature pyramid map, O_{w} and O_{H} are the width and height of the feature pyramid map, and Oₓ and O_{y} are horizontal and vertical coordinates of the feature pyramid map.

6. The method for building the adaptive scale awareness-based power transmission detection model according to claim 4, wherein the performing the spatial weight processing on the feature pyramid map at each level of the feature pyramid in the adaptive scale-aware module specifically comprises the following steps:
obtaining pixel coordinates of the expanded feature pyramid map, and determining different levels of control weight factors of each pixel coordinate; and
based on the different levels of the control weight factors, completing the spatial weight processing for the expanded feature pyramid map.

7. The method for building the adaptive scale awareness-based power transmission detection model according to claim 6, wherein the spatial weight processing for the expanded feature pyramid map is specifically expressed as follows:
$$\begin{matrix}{x}_{ij}^{′} = {α}_{ij}^{1} \cdot {x}_{ij}^{1} + {α}_{ij}^{2} \cdot {x}_{ij}^{2} + … + {α}_{ij}^{n} \cdot {x}_{ij}^{n} \\ {α}_{ij}^{1} + {α}_{ij}^{2} + … + {α}_{ij}^{n} = 1 \\ {α}_{ij}^{1} , {α}_{ij}^{2} , … , {α}_{ij}^{n} ∈ [ 0 , 1 ]\end{matrix}$$
wherein, xᵢⱼ′ is a pixel of the feature map of the awareness scale information obtained by the adaptive scale-aware module,
$${x}_{ij}^{1} , {x}_{ij}^{2} and {x}_{ij}^{n}$$
are respectively pixels on first-level, second-level and n-th level expanded feature pyramid maps,
$${α}_{ij}^{1} , {α}_{ij}^{2} and {α}_{ij}^{n}$$
are first, second and n-th level control weight factors corresponding to the pixels, and ij is a pixel coordinate on the expanded feature pyramid map.

8. The method for building the adaptive scale awareness-based power transmission detection model according to claim 4, wherein the performing offset and attention processing on the feature map of the awareness scale information in the spatial-aware module to obtain the feature map of the awareness scale information and the spatial information specifically comprises the following steps:
obtaining an offset mask and an attention mask of the feature map of the awareness scale information through convolution and group normalization, wherein the attention mask is obtained based on an activation function;
performing the analysis processing on the offset mask, and processing the feature map of the awareness scale information combined with a numerical value of the attention mask, wherein the attention mask is a logistic regression function of 0 or a positive number; and
obtaining the feature map of the awareness scale information and the spatial information.

9. The method for building the adaptive scale awareness-based power transmission detection model according to claim 8, wherein the performing the analysis processing on the offset mask specifically comprises the following step:
rounding offset coordinates in the offset mask using a max pooling method to obtain corrected coordinates, and determining an offset pixel;
the attention mask being obtained based on an activation function is specifically expressed as follows:
$$∅ ( x ) = max ( 0 , \frac{tanh ( x - φ ) + tanh ( φ )}{1 + tanh ( φ )} ) ∈ [ 0 , 1 ]$$
wherein Ø(x) is the attention mask for obtaining the feature map x of the awareness scale information, x is the feature map of the awareness scale information, φ is a preset hyperparameter, and tanh is a hyperbolic tangent function; and
the obtaining the feature map of the awareness scale information and the spatial information is specifically expressed as follows:
$$y = {{\sum }_{k = 1}}^{K} {∅}_{k} \cdot {w}_{0} x ( {p}_{0} + Δ {p}_{k} )$$
wherein y is the feature map of the awareness scale information and the spatial information, k is a serial number of a sampling point at a pixel point p₀, K is total number of sampling points at the pixel point p₀, Øₖ is an attention mask of a k-th sampling point, w₀ is a weight of the pixel point p₀ in the feature map x of the awareness scale information, p₀ is a pixel point on the feature map x of the awareness scale information, and Δpₖ is an offset mask of the k-th sampling point.

10. An apparatus for building the adaptive scale awareness-based power transmission detection model, using the method for building the adaptive scale awareness-based power transmission detection model according to claim 1, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

11. An apparatus for building the adaptive scale awareness-based power transmission detection model, using the method for building the adaptive scale awareness-based power transmission detection model according to claim 2, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

12. An apparatus for building the adaptive scale awareness-based power transmission detection model, using the method for building the adaptive scale awareness-based power transmission detection model according to claim 3, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

13. An apparatus for building the adaptive scale awareness-based power transmission detection model, using the method for building the adaptive scale awareness-based power transmission detection model according to claim 4, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

14. An apparatus for building the adaptive scale awareness-based power transmission detection model, using the method for building the adaptive scale awareness-based power transmission detection model according to claim 5, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

15. An apparatus for building the adaptive scale awareness-based power transmission detection model, using the method for building the adaptive scale awareness-based power transmission detection model according to claim 6, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

16. An apparatus for building the adaptive scale awareness-based power transmission detection model, using the method for building the adaptive scale awareness-based power transmission detection model according to claim 7, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

17. An apparatus for building the adaptive scale awareness-based power transmission detection model, using the method for building the adaptive scale awareness-based power transmission detection model according to claim 8, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.

18. An apparatus for building the adaptive scale awareness-based power transmission detection model, using the method for building the adaptive scale awareness-based power transmission detection model according to claim 9, and comprising:
an acquisition module, configured to acquire a training data set for the power transmission detection;
an analysis module, configured to perform the analysis processing on the training data set, and to iterate parameters of the awareness scale information and the spatial information combined with the training data set; and
a building module, configured to build the initial power transmission detection model that integrates the awareness scale information and the spatial information by using the YOLOv5 algorithm framework as the baseline, and to build the adaptive scale awareness-based power transmission detection model based on the iteration result.
